(19) United States
(12) Patent Application Publication
(10) Pub. No.: US 2019/0083937 A1
(43) Pub. Date: Mar. 21, 2019

(54) FILTER ELEMENT AND A METHOD OF MANUFACTURING THEREOF

(71) Applicant: BL Technologies, Inc., Minnetonka, MI (US)

(72) Inventors: Linglu YANG, Shanghai (CN); Jie HUANG, Shanghai (CN); Yun PENG, Shanghai (CN); Lin CHEN, Shanghai (CN); Su LU, Shanghai (CN)

(21) Appl. No.: 16/065,983

(22) PCT Filed: Dec. 14, 2016
(86) PCT No.: PCT/US2016/066537

§ 371 Date: Jun. 25, 2018

(30) Foreign Application Priority Data
Dec. 24, 2015 (CN) 201510988731.6

(51) Int. Cl. B01D 63/10; B01D 69/02; B01D 67/00; B01D 71/68; B01D 61/14

(52) U.S. Cl. CPC B01D 63/103; B01D 69/02; B01D 67/0016; B01D 71/68; B01D 2325/04; B01D 2323/26; B01D 2323/42; B01D 2313/143; B01D 61/145

(57) ABSTRACT

The present invention relates to a filter element and a method for manufacturing thereof. The method comprises: Providing the core tube; and rolling a membrane around the core tube. The membrane comprises a porous substrate and a filter layer on top of the porous substrate. The present invention also relates to the corresponding filter element. The filter element relating to the present invention is able to accommodate more membranes inside the same volume, resulting in high throughput and high salt rejection.

### TECHNICAL FIELD

Embodiments of the present invention relate to a filter element and a method for manufacturing thereof.

### TECHNICAL BACKGROUND

Usually, the filtering parts within a filter element include a porous substrate and filter sheet. Wherein, the filter sheet is fabricated by applying the solution forming the filter layer on a backing material (e.g., polyethylene terephthalate (PET)), including the backing layer and the filter layer. The mean pore size of the backing material is typically less than 50 microns. However, this filter element has a greater thickness, and it has fewer active areas compared to a filter element with the same volume.

Furthermore, existing filter elements are often unable to achieve a good balance between high salt rejection rate and high throughput. U.S. Patent Application Publication No. US20040222158A1 discloses a nanofiltration system for water softening with an internally graded spiral wound component. The component consists of a combination of a membrane with high salt rejection rate but low throughput, and a membrane with high throughput but low salt rejection rate, to provide salt rejection and throughput performance in-between the two membranes.

Existing filter elements in current technology are unable to completely satisfy the application requirements at present. For example, for certain applications, someone skilled in the art might still wish to reduce the thickness of the filter element, simplify the structure of the filter element, and/or provide higher throughput and higher salt rejection rate. Therefore, it is necessary to provide a new filter element and a method for manufacturing thereof.

### SUMMARY

On the one hand, some embodiments of the present invention relate to a method of manufacturing the filter element. This method comprises: providing the core tube; and rolling a membrane around the core tube. The membrane comprises a porous substrate and a filter layer on top of the porous substrate. The porous substrate has an mean pore size of 50-1,000 microns.

On the other hand, some embodiments of the present invention provide a filter element, comprising: a core tube; a membrane rolled around this core tube, wherein, this membrane comprises a porous substrate and a filter layer formed on top of the porous substrate, and a mean pore size of 50-1,000 microns; a feed spacer, which is rolled around the core tube;

Optionally, a lead porous substrate, wherein the lead porous substrate is rolled around the core tube; and optionally, a filter sheet, wherein the filter sheet comprises a backing layer and a filter layer.

Other features and aspects of the present invention will become more apparent from the following detailed description, drawings, and claims.

### DESCRIPTION OF DRAWINGS

The present invention can be better understood by using the drawings to describe the embodiments of the present invention. In the drawings:

FIG. 1 shows some embodiments of the present invention, including the Scanning Electron Microscopy (SEM) of the profile of the flow channels' porous substrate;

FIG. 2 shows the SEM of another profile of the porous substrate in FIG. 1, including the porous structure.

FIG. 3 is a diagram of the membrane manufacturing method for some of the embodiments of the present invention;

FIG. 4 is a diagram of the membrane manufacturing method for some other embodiments of the present invention;

FIG. 5 is a diagram of the membrane manufacturing method for yet other embodiments of the present invention;

FIG. 6 is a diagram of the filter component manufacturing method for some of the embodiments of the present invention; and

FIG. 7 is a diagram of the filter component manufacturing method for some other embodiments of the present invention.

### DETAILED DESCRIPTION

The following is a description of the preferred embodiments of the present invention. Unless otherwise defined, technical terms or scientific terms used in the claims and the specification should be interpreted in the ordinary sense as understood by a person of ordinary skill in the art to which the present invention pertains. The terms “one”, “a” and the like are not meant to be limiting, but rather denote the presence of at least one. The terms “including”, “comprising” and the like are intended to mean that the presence of an element or thing preceded by the word “including” or “comprising” encompasses elements or objects listed after “including” or “comprising” and their equivalents, and does not exclude other elements or objects. The terms “combined”, “connected”, “coupled” and the like, are not limited to physical or mechanical connections, nor are they limited to direct or indirect connections.

In this text, the term “core tube” refers to the tube used in the filter element, which is generally hollow with holes on its walls for the flow of filtrate.

In this text, the term “porous substrate” refers to a substrate with a porous structure. In some embodiments, this porous substrate comprises of a water-conducting substrate. In this text, the term “water-conducting substrate” refers to a polymeric substrate with a porous structure. This polymer includes, but is not limited to, ethylene terephthalate (PET), polytetrafluoroethylene, polyolefins, polyesters, or any combination thereof.

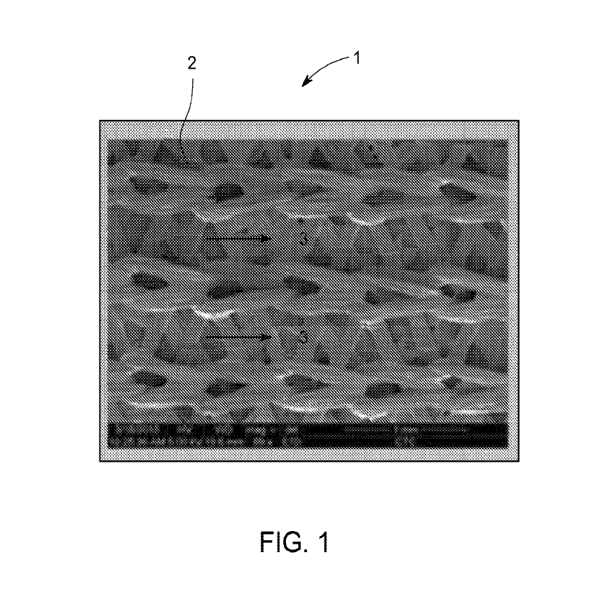

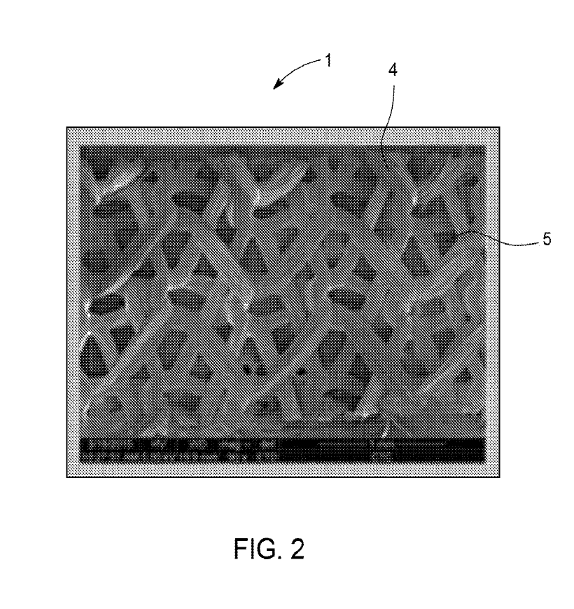

In some embodiments, this porous substrate 1 has an asymmetric structure, wherein one side 2 of this structure includes many flow channels 3 (see FIG. 1), where the other side 4 includes a porous structure 5 (see FIG. 2).

In some embodiments, the thickness of the porous substrate is 200-500 microns, 250-400 microns or 300-350 microns. In some embodiments, the average thickness of this porous substrate can be 50-1,000 microns, 100-1,000 microns, 150-800 microns, 150-400 microns, 150-300 microns or 350-1,000 microns. The mean pore size can be measured using the following method: when the porous substrate is a fibrous porous substrate, measure in accordance with GB/T 2679.14-1996; when the porous substrate is a non-fibrous porous substrate, measure using the optical or electronic microscope direct measurement method.

An example of a fibrous porous substrate includes, but is not limited to, non-woven fabric. An example of a non-fibrous porous substrate includes, but is not limited to, woven fabric.

In this text, the term “feed spacer” refers to a polymeric substrate with a porous structure. This polymer includes, but is not limited to, ethylene terephthalate (PET), polytetrafluoroethylene, polyolefins, polyesters, or any combination thereof.

In some embodiments, the feed spacer may use the same structure and material as the porous substrate, and they are able to replace each other. In some embodiments, the feed spacer has a thickness of 200-500 microns, 250-400 microns, or 300-350 microns. In some embodiments, the mean pore size of the feed spacer is 50-1,000 microns, 100-1,000 microns, 150-800 microns, 150-400 microns, 150-300 microns, or 350-1,000 microns.

In some embodiments, the feed spacer has a different structure than the porous substrate. In some embodiments, the opposite sides of the feed spacer have the same structure, both having the same porous structure.

In some embodiments, the membrane includes a porous substrate as well as a filter layer forming on the surface of the porous substrate (i.e. single-sided membrane). The thickness of this membrane may be 100-1,000 microns, 280-800 microns, or 300-350 microns.

In some embodiments, this membrane comprises a porous substrate as well as filter layers forming on both surfaces of the porous substrate (i.e.\ double-sided membrane). The thickness of this membrane may be 100-1,000 microns, 280-800 microns, or 300-450 microns.

Membranes relating to embodiments of the present invention may have both water-conducting and filtering functionalities. Compared to known membranes (such as the filter sheet), this membrane is able to reduce the thickness of the filter element, as well as having a better balance between throughput and salt-rejection rate.

In this text, the term “filter layer” generally refers to a layer that is able to perform filtering using principles such as microfiltration (MF), ultrafiltration (UF), nanofiltration (NF), reverse osmosis (RO), forward osmosis (FO) and gas separation. In some embodiments, the filter layer comprises, but is not limited to, the microfiltration layer, the ultrafiltration layer, the nanofiltration layer, the reverse osmosis layer, the forward osmosis layer, and any combination thereof.

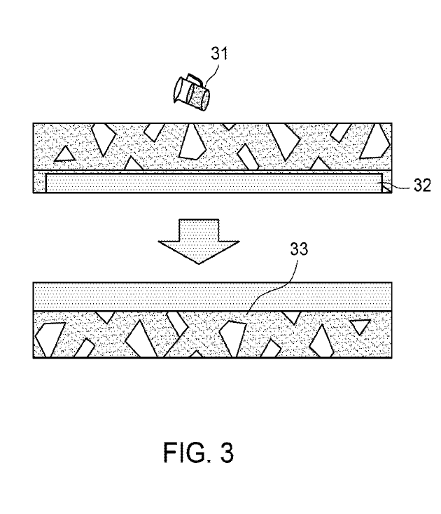

In some embodiments, this filter layer is formed using the method of solution solidifying. In some embodiments, the membrane is fabricated using the method as shown in FIG. 3. First, provide a porous substrate with many pores. Place the porous substrate on the operation table, and place the porous substrate with the side containing the flow channels facing the operation table. Use the pre-filling solution 31 to fill the porous substrate.

In this text, the term “pre-filling solution” refers to a filling solution used to fill the pores within the porous substrate to facilitate the subsequent application of the filter layer. In some embodiments, the pre-filling solution comprises water, an organic solvent, or a combination of the two. In some embodiments, the organic solvent includes alcohol, glycerin, ethylene glycol, N,N-dimethylformamide (DMF), N-methylpyrroline (NMP), Dimethyl sulfoxide (DMSO), Dimethylacetamide (DMAc), or a combination thereof. In some embodiments, the alcohol includes methanol, ethanol, isopropanol, or a combination thereof.

After filling in with the pre-filling solution, remove the excess pre-filling solution from the porous substrate, whereby the pre-filling solution occupies the lower region of the porous substrate (see mark 32 in FIG. 3), resulting in a porous substrate with the side containing the flow channels carrying the pre-filling solution. Subsequently, the solution forming the filter layer is poured onto a porous substrate carrying the pre-filling solution, which rapidly solidifies and forms a filter layer 33 on top of the porous substrate. The filter layer is formed directly on top of the porous substrate, thereby forming the membrane. In some embodiments, this solution that forms the filter layer includes, but is not limited to, polysulfone (PSU), polypropylene, polyvinylidene fluoride (PVF), polyethersulfone (PES), polyacrylonitrile (PAN), polyvinyl chloride (PVC), polyvinyl alcohol (PVA), cellulose acetate (CA), polyimide (PI), polytetrafluoroethylene, nylon, polyvinyl formal, or a combination thereof.

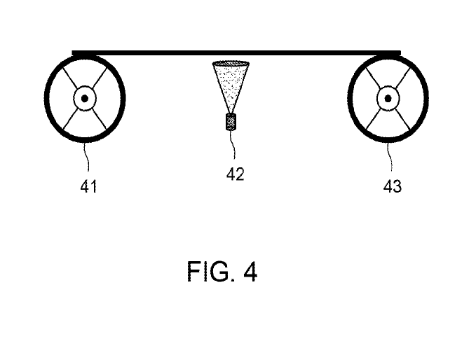

In some embodiments, this membrane is fabricated using the method of continuous casting as shown in FIG. 4. First provide a porous substrate with many pores. Both ends of this porous substrate are each rolled around a pair of rollers, rollers 41 and 43. The porous substrate can be unrolled on the roller 41, and rerolled on roller 43, thereby operating between the two rollers. A row of parallel nozzles 42 are arranged between the pair of rollers, wherein nozzles 42 are fluidly connected to the container containing the pre-filling solution (not shown). The width of the roll of nozzles matches the width of the porous substrate.

During operation, the porous substrate unrolls from roller 41, passes through parallel nozzles 42 at a speed suitable for the application of the pre-filling solution, and then rerolls around roller 43. When passing through parallel nozzles 42, the nozzles may spray the pre-filling solution onto the porous substrate using different flow rates to provide a porous substrate on the side containing the flow channels that carries the pre-filling solution.

Subsequently, the porous substrate passes through the coating head (not shown), which coats the solution forming the filter layer onto the surface of the porous substrate with the pre-filling solution applied. Before rerolling around roller 43, the solution forming the filter layer solidifies, forming a smooth and even filter layer on the porous substrate, therefore forming the membrane.

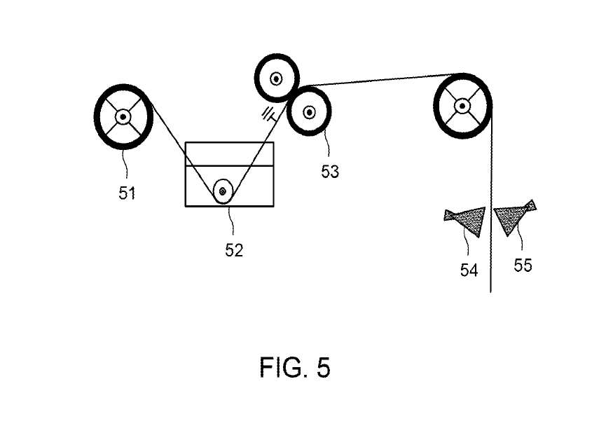

In some embodiments, this membrane is fabricated using the method of continuous casting as shown in FIG. 5. As shown in FIG. 5, first provide a porous substrate with many pores. One end of this porous substrate is rolled around roller 51, and during operation, the porous substrate is unrolled from roller 51. The unrolled porous substrate is dip-coated into container 52 containing the pre-filling solution, thereby allowing the pre-filling solution to occupy the porous substrate. After leaving container 52, the porous substrate containing the pre-filling solution passes through a pair of nip rolls, squeezing out the excess pre-filling solution from the surface of the porous substrate, with only the pre-filling solution remaining in the middle portion of the porous substrate, thereby forming a pre-filling solution layer that occupies only the middle portion of the porous substrate.

Subsequently, pass the porous substrate with the pre-filling solution only occupying the middle portion of the porous substrate through a pair of slot die coating heads 54 and 55. Here, the solution forming the filter layer is sprayed onto the surface of the porous substrate. The solution forming the filter layer partially permeates the surface of the porous substrate containing the pre-filling solution, forming smooth, even filter layers on both surfaces of the porous substrate after solidification.

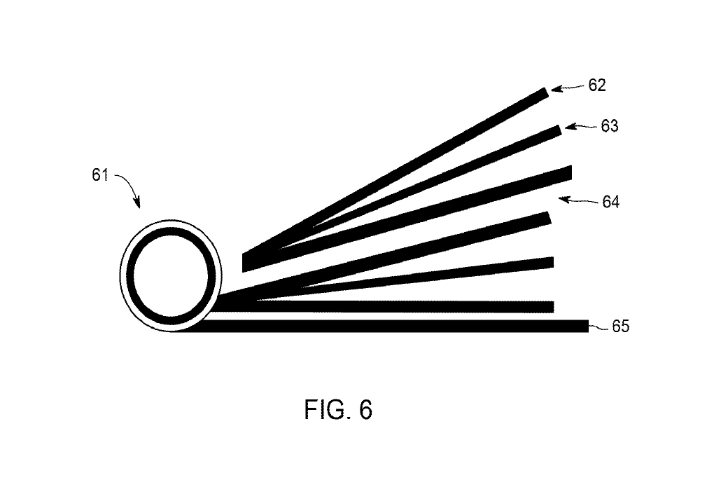

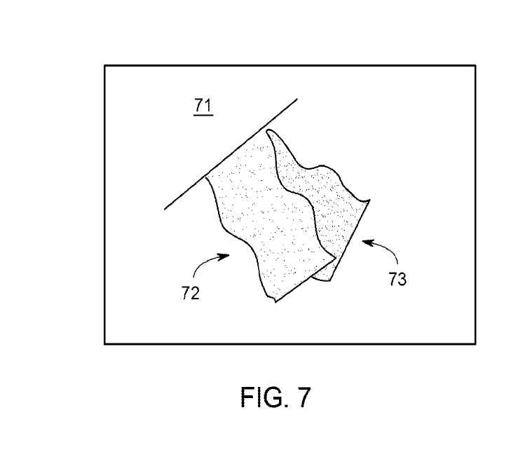

In some embodiments, the filter element relating to the present invention is fabricated using the following method: provide core tube 61, and roll the membrane (see, 62, 64 of FIG. 6, or 72 of FIG. 7) around the core tube. The membrane comprises a porous substrate as well as the filter layer forming on top of the porous substrate. In some embodiments, the core tube is rolled around one end of the lead porous substrate. This lead porous substrate can facilitate the laying out of the membrane, as well as facilitate the rolling of the membrane around the core tube.

In some embodiments, as shown in FIG. 6, first provide core tube 61 installed on the rotating axle. The core tube 61 rolls up and guides one end of the porous substrate 65. In some embodiments, fold membranes 62 and 64 into two, such that the smooth, even filter layer surface is facing the inside. Then, insert feed spacer 63 into the folded membrane, gluing the open edges of the folded membranes that are adjacent to each other, thereby providing a membrane envelope. Layer the fabricated membrane envelope on the lead porous substrate 65. In some embodiments, the outer edges of the membrane envelope or the portion close to the edges of the membrane envelope are glued together, thereby fixing the membrane envelope into place. Finally, roll up the membrane envelope around the core tube, forming the filter element comprising core tube 61, membrane 62 and 64, feed spacer 63 and the lead porous substrate 65.

In some embodiments, as shown in FIG. 7, the core tube 71 installed on the rotating axel is provided. In some embodiments, the core tube 71 can be rolled around one end of the lead porous substrate. Provide filter sheet 73 and membrane 72. In some embodiments, membrane 72 is folded into two as described above, such that the smooth, even filter layer surface is facing the inside. In some embodiments, the feed spacer is inserted into the folded membrane. In some embodiments, the open edges of the folded membranes that are adjacent to each other are glued together, providing a membrane envelope. Use the same method to prepare the filter sheet envelope.

The filter sheet is fabricated by applying the solution that forms the filter membrane onto the backing material (e.g. PET), including the backing layer and the filter layer. The mean pore size of the backing layer is smaller than the mean pore size of the porous substrate. In some embodiments, the mean pore size of the backing layer is smaller than 100 microns, smaller than 80 microns, or smaller than 50 microns.

Layer and roll up the fabricated membrane envelope and the filter sheet envelope onto the core tube. In some embodiments, the fabricated membrane envelopes and the filter sheet envelopes are layered in a non-alternating manner. In some embodiments, the fabricated membrane envelopes and the filter sheet envelopes are layered in an alternating manner.

In some embodiments, the outer edges or the portion close to the edges of the membrane envelope and filter sheet envelope are glued together to fix the membrane envelope and the filter sheet envelope into place. Roll up the membrane envelope and the filter sheet envelope around the core tube, forming the filter element comprising core tube 71, membrane 72, filter sheet 73, and the feed spacer. In some embodiments, the filter element may comprise the lead porous substrate.

In some embodiments, the filter element comprises: core tube 61, one or more membranes rolled around core tube 61 (see 62 and 64 in FIG. 6), feed spacer and an optional lead porous substrate. In some embodiments, membranes 62 and 64 comprise one or two filter layers. In some embodiments, one end of the lead porous substrate is rolled around the core tube. In some embodiments, the feed spacer is inserted in between the folded membrane.

In some embodiments, the filter element comprises: core tube 71, one or more membranes rolled around the core tube 71 (see 72 in FIG. 7), feed spacer, optional one or more filter sheet 73, and optional lead porous substrate. In some embodiments, membrane 72 comprises one or two filter layers. In some embodiments, filter sheet 73 is rolled around core tube 71 together with one or more membranes 72 in a non-alternating manner. In some embodiments, filter sheet 73 is rolled around core tube 71 together with one or more membranes 72 in an alternating manner. In some embodiments, one end of the lead porous substrate is rolled around the core tube. In some embodiments, the feed spacer is inserted in between the folded membrane or filter sheet.

In some embodiments, it is unnecessary to fold the membrane and the filter sheet. The membrane, filter sheet and feed spacer are stacked in order and then rolled around the core tube. In some embodiments, after the membrane and the filter sheet are cropped to the appropriate sizes, it is unnecessary to fold the membrane and the filter sheet. The membrane, filter sheet and feed spacer are stacked in order and then rolled around the core tube.

Compared to filter elements not comprising the membrane of the present invention, the membranes of some embodiments of the present invention are not traditional filter sheets. They omit the backing layer, and the filter layer is directly formed on top of the porous substrate, eliminating the procedure of welding the porous substrate onto the filter sheet required in existing techniques, simplifying the process, as well as greatly reducing the cost of materials. In some embodiments of the present invention, due to the lack of a welding process, the time required for rolling up the membrane can be reduced by 25% compared to the regular filter elements.

At the same time, compared to filter elements not comprising the membranes relating to the embodiments of the present invention, the thickness of the filter elements relating to some embodiments of the present invention is smaller. With the same volume, the filter elements relating to some embodiments of the present invention are able to accommodate more membranes, thereby including larger active filtering regions. Therefore, the filter elements of some embodiments of the present invention are able to achieve a higher throughput and salt-rejection rate. The filter elements of some embodiments of the present invention also have significant pressure resistance. In some embodiments of the present invention, it is possible to eliminate the extra porous substrate used for water conduction, or to only have the water-conducting substrate, in order to reduce the thickness of the filter element, thereby providing a larger active filtering region.

### EXPERIMENTAL EXAMPLES

### Example 1: Membrane Fabrication

As shown in FIG. 3, provide a water-conducting substrate with a thickness of 250 microns. This substrate comprises many pores with a mean pore size of approximately 150-400 microns. The water-conducting substrate has an asymmetric structure (see FIGS. 1 and 2), wherein one side contains flow channels and the other side has a porous structure. Place the water-conducting substrate carefully onto the glass plate, placing the side of the water-conducting substrate containing flow channels toward the glass plate.

Use water as a pre-filling solution to fill the water-conducting substrate, then place filter paper or absorbent pad into contact with the water-conducting substrate containing water using the pressure from a rubber roller, and absorb the excess water. Thereby, water occupies the lower region of the water-conducting substrate, forming a water-conducting substrate containing water.

Pour 17% (wt/vol) polysulfone (PSU) (with N,N-dimethylformamide as solvent) onto the water-conducting substrate containing the pre-filling solution, then rapidly move it to a hydrogel bath, using a solidifying PSU solution to form the filter layer. The filter layer is directly formed on top of the water-conducting substrate. Preserve the membrane containing the PSU ultrafiltration layer and the water-conducting substrate by submersing it in water.

After measurement, the thickness of this membrane is approximately 350 microns, approximately 90% of the thickness of filter elements fabricated by gluing together a 130 microns UF filter sheet and a 250 microns water-conducting substrate.

In addition, it has been observed that the membrane fabricated has an even and smooth membrane surface, as well as no noticeable pinhole defects.

### Example 2: Double-Layer Membrane Fabrication

Provide a water-conducting substrate with a thickness of 350 microns. This substrate comprises many pores with a mean pore size of approximately 150-400 um. The water-conducting substrate has an asymmetric structure, with one side containing flow-channels and the other side having a porous structure.

Place the water-conducting substrate on the glass plate, and place the side of the water-conducting substrate containing the flow channels facing the glass plate. Use water as a pre-filling solution to fill the water-conducting substrate, then place filter paper or absorbent pad into contact with the water-conducting substrate containing water using the pressure from a rubber roller, and absorb the excess water.

Pour 17% (wt/vol) polysulfone (PSU) (with N,N-dimethylformamide as solvent) onto the water-conducting substrate containing the pre-filling solution, then rapidly move it to a hydrogel bath, using a solidifying PSU solution to obtain the membrane.

Place the membrane obtained onto the glass plate, allowing the side containing the flow channels to face up, and load the pre-filling solution onto the flow channel side. Subsequently, place filter paper or absorbent pad into contact with the water-conducting substrate containing the filling solution using the pressure from a rubber roller, and absorb the excess water.

Pour 17% (wt/vol) polysulfone (PSU) (with N,N-dimethylformamide as solvent) onto the water-conducting substrate containing the pre-filling solution one more time, then rapidly move it to a hydrogel bath, using a solidifying PSU solution to obtain the membrane.

After measurement, the thickness of the fabricated membrane is approximately 450 microns. In addition, it has been observed that the membrane fabricated has an even and smooth membrane surface, as well as no noticeable pinhole defects.

### Example 3: Filter Element Fabrication

As shown in FIG. 6, using a membrane fabricated from Example 1, the surface contains a smooth and even PSU filter layer.

First provide the core tube installed on the rotating axle, with one end of the PET water-conducting substrate rolled up around the core tube. Fold the membrane fabricated in Example 1 into two, such that the smooth and even PSU filter membrane surface is facing inward. Subsequently, insert the feed spacer into the folded membrane, glue together the open edges of the folded membrane that are adjacent to each other to provide the membrane envelope.

Layer the fabricated membrane envelope onto the water-conducting substrate, wherein the outer edges or the portion close to the edges of the membrane envelope are glued together, fixing the membrane envelope into place. Finally, roll up the membrane envelope around the core tube, forming the filter element comprising the core tube, membrane, PET water-conducting substrate and the feed spacer.

Compared to filter elements requiring the water-conducting substrate to be welded, since the filter element fabricated in Example 3 does not require the individual welding process, the time required for rolling up the membrane can be reduced by 25%. At the same time, with the same volume, it is able to accommodate more membranes (approximately 5%-10%). Therefore, in an element with the same volume it is able to accommodate a larger active filtering area.

### Example 4: Filter Element Fabrication

As shown in FIG. 7, using the membrane fabricated in Examples 1-2, the surface has a smooth, even PSU filter layer.

First provide the core tube installed on the rotating axle, with one end of the PET water-conducting substrate rolled up around the core tube. Fold the membrane fabricated in Example 1 into two, such that the smooth and even PSU filter membrane surface is facing inward. Subsequently, insert the feed spacer into the folded membrane, glue together the open edges of the folded membrane that are adjacent to each other to provide the membrane envelope. Use the same method to prepare the filter sheet envelope.

Layer the fabricated membrane envelope and the filter sheet envelope onto the water-conducting substrate in an alternating manner, wherein the outer edges or the portion close to the edges of the membrane envelope are glued together, to fix the membrane envelope into place. Finally, the membrane envelope is rolled up around the core tube, forming the filter element comprising the core tube, membrane, filter sheet, PET water-conducting substrate and the feed spacer.

Compared to the filter element that requires the water-conducting substrate to be welded, due to the lack of an individual welding process, the membrane rolling time can be 25% less than the regular filter elements. At the same time, with the same volume, it is able to accommodate more membranes (approximately 16%). Therefore, in an element with the same volume it is able to accommodate a larger active filtering area.

### Example 5: Carrying out Performance Testing on the Filter Element Fabricated in Example 4

The filter element fabricated in Example 4 has been tested using 2,000 ppm NaCl solution and under a pressure of 220 psi. The filter element fabricated in Example 4 shows a high throughput (approximately 126 GDP (gallon per day)) and high salt-rejection rate (96.7%). Compared to filter elements only comprising the filter sheet, the filter element fabricated in Example 4 has a throughput of approximately 18%. Tests on the filter element continued for 180 hours to test the stability of the filter element under pressure. At the conclusion of testing, the throughput of the filter element was 100 GPD, salt-rejection rate was 97.8%, showing that the membrane is durable under pressure.

While the present invention has been shown and described with reference to specific embodiments thereof, it will be understood by those skilled in the art that many modifications and variations can be made thereto. It is, therefore, to be understood that the appended claims are intended to cover all such modifications and variations insofar as they are within the true spirit and scope of the invention.

1. A method of preparing a filter element, comprising:
providing a core tube; and
rolling a membrane around the core tube, wherein the membrane comprises a porous substrate and a filter layer on the porous substrate, and the porous substrate has a mean pore size of 50-1000 microns.

2. The method according to claim 1, further comprising:
folding the membrane;
inserting a feed spacer within the membranes as folded to provide an envelope of the membrane; and
rolling the envelope of the membrane around the core tube.

3. The method according to claim 2, further comprising:
providing a filter sheet, wherein the filter sheet comprises a backing layer and a filter layer, and folding the filter sheet;
inserting a feed spacer within the filter sheet as folded to provide an envelope of the filter sheet; and
rolling the envelope of the filter sheet around the core tube.

4. The method according to claim 3, wherein the envelope of the membrane and the envelope of the filter sheet are rolled around the core tube, alternatively.

5. The method according to claim 1, further comprising:
providing a filter sheet, wherein the filter sheet comprises a backing layer and a filter layer;
providing a feed spacer; and
stacking the membrane, the filter sheet and the feed spacer in order, and then rolling them around the core tube.

6. The method according to claim 1, wherein the porous substrate has a mean pore size of 100-1000 microns.

7. The method according to claim 1, wherein the membrane has a thickness of 280-1000 microns, 300-800 microns, or 300-500 microns.

8. The method according to claim 1, wherein a side of the porous substrate comprises flow channels, and another side of the porous substrate comprises a porous structure.

9. A filter element, comprising:
a core tube;
a membrane rolled around the core tube, wherein the membrane comprises a porous substrate and a filter layer on the porous substrate, and the porous substrate has a mean pore size of 50-1000 microns;
a feed spacer, wherein the feed spacer is rolled around the core tube;
optionally, a lead porous substrate, wherein the lead porous substrate is rolled around the core tube; and
optionally, a filter sheet, wherein the filter sheet comprises a backing layer and a filter layer.

10. The filter element according to claim 9, wherein the filter sheet and the membrane are rolled around the core tube, alternatively.
